(19) United States
(12) Patent Application Publication
(10) Pub. No.: US 2009/0204480 A1
(43) Pub. Date: Aug. 13, 2009

(54) System for Providing Businesses with Intelligence about Lost Sales

(76) Inventor: Mark Reginald James, Sydney (AU)

Correspondence Address: Mark James, PO Box 500, Pymble, 2073, omitted

(21) Appl. No.: 12/369,008

(22) Filed: Feb. 11, 2009

Related U.S. Application Data
(60) Provisional application No. 61/065,245, filed on Feb. 11, 2008.
(60) Provisional application No. 61/065,244, filed on Feb. 11, 2008.
(60) Provisional application No. 61/050,250, filed on May 4, 2008.

(51) Int. Cl. G06Q 10/00; G06Q 30/00

(52) U.S. Cl. 705/10; 705/14

(57) ABSTRACT

A system that makes it possible for a maker, distributor, or vendor of a product to survey those who purchase a competing product, allowing them to determine why they lost that sale. An auction system for determining which questions are posed to a purchaser is also disclosed.

### CROSS-REFERENCE TO RELATED APPLICATIONS

World Wide Web addresses rbate.com and rbate.com/makers/faqs#qbids

The present application claims the priority benefit of U.S. provisional patent applications U.S. 61/065,245 and U.S. 61/065,244, filed Feb. 11, 2008, and U.S. 61/050,250, filed May 4, 2008.

### STATEMENT REGARDING FEDERALLY SPONSORED RESEARCH OR DEVELOPMENT

Not applicable.

### BACKGROUND OF THE INVENTION

Although such intelligence would be valuable, it is currently difficult for a business to determine when and why a sale was lost to a competitor.

One such way is for the business to regularly question those on a list of known customers and potential customers. This requires a great deal of work, and is unable to access purchasers not known to the business.

Another way to gather information about lost sales is to conduct market research surveys in either the general population or a somewhat targeted slice of the general population. However the less targeted such a survey, the more expensive the research relative to the information gained about the relevant product markets.

### BRIEF SUMMARY OF THE INVENTION

The disclosed invention allows a business to undertake market research with a highly-select group-people who have purchased a product that competes with a product that the business makes or sells. This allows the business to find out why certain consumers eschewed their product for another.

Purchasers can be given two incentives to answer questions posed by these businesses: Answering these questions can be a task undertaken during a claim the purchaser makes for a rebate from the maker or distributor of the product that has been purchased. The rebate gives the purchaser an incentive to properly complete the claim, including the survey questions. A further incentive can be provided by paying purchasers for answering these questions from funds provided by the businesses posing the questions.

A question auction system is used to both select a small set of questions that will be posed to a purchaser from a larger pool of candidate questions, and to set a fair price for answers to those questions.

A bid credit system that can help overcome the reluctance of product makers to allow purchasers of their own products to be questioned is also disclosed.

### DETAILED DESCRIPTION OF THE INVENTION

The invention can be manifest as an online service that allows businesses who make, distribute, or sell a product (“makers”) to write survey questions, and have those questions answered by purchasers of competing products made by other businesses.

An incentive is provided for purchasers to visit the service after they have made their purchase, during which visit they are asked to answer a list of questions written by businesses. One form of incentive is a cash payment for each answer purchasers provide. This payment is sourced from the business that has written that question and receives the answer.

Alone, or in adjunct to these payments, the maker, distributor, or vendor of the product that has been purchased (“the product maker”) can offer the purchaser an incentive to visit the service through the offer of an incentive such as a prize, prize draw entry, or—the example used here—a cash rebate.

The product maker will more likely agree to provide rebates if, in addition to answering questions posed by makers of other products, purchasers can provide some value to the product maker in the process of claiming their rebates through the service. Such value may be in the form of an ability to themselves survey these people who have purchased one of their products, an ability to discover what professional purchasing help purchasers have made use of (and to reward those helpers), an enhanced ability to question purchasers of other maker's products during subsequent rebate claims made on those other products (for example the bid credit system discussed below), or by having the businesses who are the recipients of the answers make payments to the maker of the claimed product.

Another desirable service feature is implementation of filtering and monitoring mechanisms that prevent other businesses from asking questions that attempt to obtain a purchaser's identity or contact information. This restriction preserves the integrity of the customer relationship, making product makers more comfortable about allowing their customers to be exposed to the questions of competing makers.

Because knowledge of a product's identity, category, and availability region are used in the bid system that is a subject of this invention, an advantage of making the rebate incentive possible by providing value to the product maker is that payment of the rebate requires that the product be registered with the service, which allows the service to ask product makers to supply information about the product, rather than relying on the purchaser to supply this information. Confirmation of rebate eligibility is also one way through which the service can identify legitimate purchasers.

In order to preserve the quality of answers, the number of questions given to a product purchaser that have been posed by makers of other products must be limited to a small number. This creates a competitive market for the right to fill one the available question slots for each purchase. This competition can be resolved through a suitable single or category-dependent per-question price, or through bids placed by product makers.

A given maximum bid is associated with a particular question that product makers have written and registered with the service, and can also be associated with a particular product category.

Because many products are only available in certain parts of the world, it is desirable to further associate one or more availability-regions with each product and with each bid, in addition to their product category attributes. Availability-region and product category combinations place each product and each question bid into one or more markets. Just as the products compete in these real-world markets, competition between bids is resolved separately for each market.

A bid that is created with a given availability-region and product category participates in all bid markets that have (1), a product category that is equal to or is a sub-category of the bid's product category, and (2), a product availability-region that either contains or is contained by the bid's availability-region.

An alternative to associating a bid with a market would be to allow product makers to associate bids with a specific set of products. Reliable identification of a product without relying on a match between names supplied by the bidder and product purchaser would require products to be registered with the service. Such registration would be a feature of a purchaser rebate system, as described above.

At most one bid is able to exist for each combination of product maker, question, and market. Further associated with a bid is a maximum bid amount, a spending limit, and a bid expiry date.

Given that a bid is unexpired, that the spending limit will not be exceeded if a question is successfully posed, and that the bid has not been made by the maker of the product that is the subject of a purchase, then when a purchaser visits the service the set of questions posed are the participating (related-market) bids that presently have the top N maximum bid amounts, where N is the number of question slots available, with ties resolved by question rotation.

The amount paid to the service by the makers that wrote the successfully-posed questions is not the maximum bid amount, but instead the common amount of the highest unsuccessful bid, or a fixed minimum amount if the number of active matching bids is less than or equal to the number of slots, plus an optional service fee. A proportion of the amount before the fee is added can be paid to the purchaser as an incentive to provide accurate and comprehensive answers, and as a reward for the information provided.

If a question has been supplied to the purchaser but not answered, the maker can either not be charged, or can be charged a reduced fee. The advantage of the latter option is that the maker is given an incentive to improve a question that is wasting claim slots because it is difficult to understand or answer.

The charge can also be waived, and payment to the purchaser refused, if an incomplete, unintelligible, or insufficiently long answer is provided.

When a maker has paid the service for obtaining answers from a purchaser, the service makes those answers available to that maker through an online account the maker holds with the service. Answers can be viewed individually, and, for multiple-choice questions, as aggregate statistics.

An optional credit system can also be implemented in cases where the maker of the purchased product has provided part of the incentive for the purchaser to visit the service, perhaps through a rebate payment as described above. In such cases the product maker may feel that their incentive payment is associated with an opportunity for their competitors to question their customers. The credit system associates levels of bid credit with product maker, product category, and availability-region triples. A bid only remains active while the credit available to that product maker in the bid's market is greater than zero. For each type of product this mechanism balances the ability to question purchasers of that type of product with exposure to such questions. Unless product makers are provided with initial question credits on registration, a maker will have to pay at least one rebate before any of their question bids can become active.

When a product purchaser submits a rebate claim, the maker of that product earns bid credit in a credit pool defined by the combination of that product's availability-region and market category, where a product's market category is either the product's most refined categorization, or is the super-category of this category that encompasses all products that compete with the product.

The following rules describe how credit can be used on bids that question product purchasers:
1. The availability-region of the bid must match the availability-region of a credit the maker holds. Without this requirement for an exact match, product makers would have an incentive to give their products artificially-wide availability-regions, allowing the credit they earn to be applied to a wider class of bids.
2. The category of the purchased product is equal to or is a sub-category of the credit applied in Point
3. The credit available to the maker in a pool that complies with Points 1 and 2 is greater than or equal to a non-zero credit charge value.
4. The availability-region of the purchased product contains or is contained by the availability-region of the bid.
5. The category of the purchased product is equal to or is a sub-category of the bid's category.

Together, Points 3 and 4 cause a bid to cover all competing products that are available to some consumers in the bid's region and category group.

The following example illustrates these rules:

A manufacturer of carpet sells, and has a rebate claimed on, a length of a type of carpet that is only available in the United States, earning them 1 point of bid credit in availability-region “United States” and market category “Flooring”.

This manufacturer then creates a bid for a particular survey question, setting the availability-region of the bid to “United States”, and the product category of the bid to “Wooden Flooring”. This bid covers products in market “wooden flooring available throughout the United States”, as well all wooden flooring markets for which the product's availability-region overlaps the United States (world-wide, North America, a US State, a US county, a US city, etc.). This bid is able to be successful during rebate claims on products that have a category and availability-region that place the product in one of these markets, and the bid will compete with other bids that cover this same market. The resolution of this competition fills the limited number of slots for bid questions that are given to the rebate claimer.

This bid has one point of bid credit in these markets because the bid's region matched the region of a credit, and the bid's category is a sub-category of that same credit. Given a sufficiently high bid, the bid is able to be successful for wood flooring products that are, for example, either available only in Texas or are available world-wide, because all these products are available somewhere in the United States, allowing the original manufacturer to question purchasers of any of these products.

If the bid was instead given an availability region of Texas, the bid could not be successful because the manufacturer does not have credit in this region. Thus although the manufacturer can get feedback from purchasers of wooden flooring products available somewhere in the United States, including products only available in Texas, they would not be able to restrict this feedback to products only available in Texas, because the carpet product they sold had a wider region of distribution. Such a restriction prevents sellers of products available world-wide from earning credit in low-value markets and applying that credit to specific high-value markets. For example, bid credit earned through the sale in Nigeria of a radio with world-wide availability could not be used to only question radio buyers located in the United States, but could be used to question all radio buyers world-wide, including US buyers.

If the manufacturer instead created a bid with the bid's product category set to “All Categories”, it would still cover the same markets as the first bid. This is because although the bid now covers every product category (the sub-categories of “All Categories”), the single non-zero credit pool restricts bid activity to sub-categories of this credit category.

1. A system that allows a business to pose one or more questions to persons who have purchased a product that (a), the business does not make or sell, and that (b), can in some way substitute for a product made, distributed, or sold by the business, where the purchaser is given an incentive to view or answer the questions.

2. The system of claim 1 where the purchaser is given an incentive to answer such questions by posing the questions during a claim that the purchaser must make in order to receive a cash rebate or other reward provided by a business that has made, distributed, or sold the purchased product.

3. The system of claim 1 where the purchaser is given an incentive to answer a question by a payment from the business that posed the question.

4. The system of claim 1 where the number of such questions posed to a purchaser is limited, with the set of questions posed being decided by a bidding system.

5. The bidding system of claim 4 where a particular question is associated with each bid, and where the questions posed are those associated with the highest bids.

6. The bidding system of claim 5 where a minimum bid amount is imposed.

7. The bidding system of claim 5 where the bidder is only charged if the purchaser provides a suitable answer to that question.

8. The bidding system of claim 7 where the bidder for each question answered on a particular claim pays the same amount, irrespective of the bid amount.

9. The bidding system of claim 5 where a charge is made for posing the question to the purchaser, even if no answer, or no suitable answer, was provided.

10. The bidding system of claim 4 where different bid markets exist for different categories of products.

11. The bidding system of claim 4 where different bid markets exist for different product markets, which are each a combination of a product category and a product availability region.

12. The bidding system of claim 4 where a bidder can limit their total spending for a given bid.

13. The bidding system of claim 4 where a bidder can limit the time period over which their bid remains active.

14. The bidding system of claim 2 where some proportion of a successful bid on a claim is paid to the party who bears the cost of the reward for that claim.

15. The bidding system of claim 2 where a bidder can only make a bid in a product category or market if they have sufficient bid credit, where bid credit accrues when a claim is paid for a product that the bidder makes, distributes, or sells, and is depleted when a question is successfully posed or answered.

16. The system of claim 15 where each bidder has separate bid credit pools for different product markets.

17. The system of claim 1 where questions that ask for information which could identify the person claiming the rebate or reward are rejected and are never posed.
